(19) United States
(12) Patent Application Publication
(10) Pub. No.: US 2009/0148285 A1
(43) Pub. Date: Jun. 11, 2009

(54) MULTI-SECTION WIND TURBINE ROTOR BLADES AND WIND TURBINES INCORPORATING SAME

(75) Inventor: Hartmut A. Scholte-Wassink, Lage (DE)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/951,362

(22) Filed: Dec. 6, 2007

(51) Int. Cl. F01D 5/12; F03D 11/00

(52) U.S. Cl. 416/23; 416/141

(57) ABSTRACT

A multi-section blade for a wind turbine comprising at least one non-pitchable section and at least one pitchable section is provided. The non-pitchable section is configured to be fixed to a hub of the wind turbine. The pitchable section is configured to be rotated about a pitch axis which is substantially parallel to the span of the multi-section blade. A pitch bearing and a pitch motor are located within the blade and near the non-pitchable section and pitchable section interface.

### BACKGROUND OF THE INVENTION

This invention relates to wind turbines, and more particularly to wind turbines having rotor blades built in more than one section.

Recently, wind turbines have received increased attention as an environmentally safe and relatively inexpensive alternative energy source. With this growing interest, considerable efforts have been made to develop wind turbines that are reliable and efficient.

Generally, a wind turbine includes a rotor having multiple blades. The rotor is mounted within a housing or nacelle, which is positioned on top of a truss or tubular tower. Utility grade wind turbines (i.e., wind turbines designed to provide electrical power to a utility grid) can have large rotors (e.g., 30 meters or more in diameter). Blades on these rotors transform wind energy into a rotational torque or force that drives one or more generators, rotationally coupled to the rotor through a low speed shaft and/or a gearbox. The optional gearbox may be used to step up the inherently low rotational speed of the turbine rotor for the generator to efficiently convert mechanical energy to electrical energy, which is fed into a utility grid. Some turbines (i.e., direct drive) utilize generators that are directly coupled to the rotor without using a gearbox.

As the power generating capacity of wind turbines increase, the dimensions of their rotor blades and other components also increase. At some point, practical transportation and logistics limits may be exceeded. These non-technical limitations lead to constraints on the energy production ratings of on-shore wind turbines.

### BRIEF DESCRIPTION OF THE INVENTION

In one aspect, the present invention provides a multi-section blade for a wind turbine comprising at least one non-pitchable section and at least one pitchable section. The non-pitchable section is configured to be fixed to a hub of the wind turbine. The pitchable section is configured to be rotated about a pitch axis which is substantially parallel to the span of the multi-section blade. A pitch bearing and a pitch motor are located within the blade and near the non-pitchable section and pitchable section interface.

In another aspect, the present invention provides a wind turbine having a plurality of multi-section blades. The wind turbine includes a hub integrally formed with a low speed shaft. The blades include at least one non-pitchable blade section configured to be fixed to the hub, and at least one pitchable blade section. The pitchable blade section is configured to be rotated about a pitch axis, and the pitch axis is oriented substantially parallel to the span of an assembled blade. The blade also comprises a pitch means for rotating the pitchable section about the pitch axis, and the pitch means are located within the multi-section blade and near an interface of the non-pitchable blade section and the pitchable blade section.

In yet another aspect, the present invention provides a multi-section blade for a wind turbine comprising at least one, aerodynamically shaped, non-pitchable section configured to be fixed to a hub of the wind turbine. At least one pitchable section is configured to be rotated about a pitch axis, and the pitch axis is oriented substantially parallel to the span of the multi-section blade. A pitch means for rotating the pitchable section about the pitch axis, is located within the multi-section blade and near an interface of the non-pitchable section and the pitchable section.

### BRIEF DESCRIPTION OF THE DRAWINGS

FIG. 1 is an illustration of an exemplary configuration of a wind turbine configuration of the present invention.

FIG. 2 is an illustration of a side view of a multi-section blade that could be used with the wind turbine of FIG. 1.

FIG. 3 is an illustration a side view of a multi-section blade according to another embodiment of the present invention.

### DETAILED DESCRIPTION OF THE INVENTION

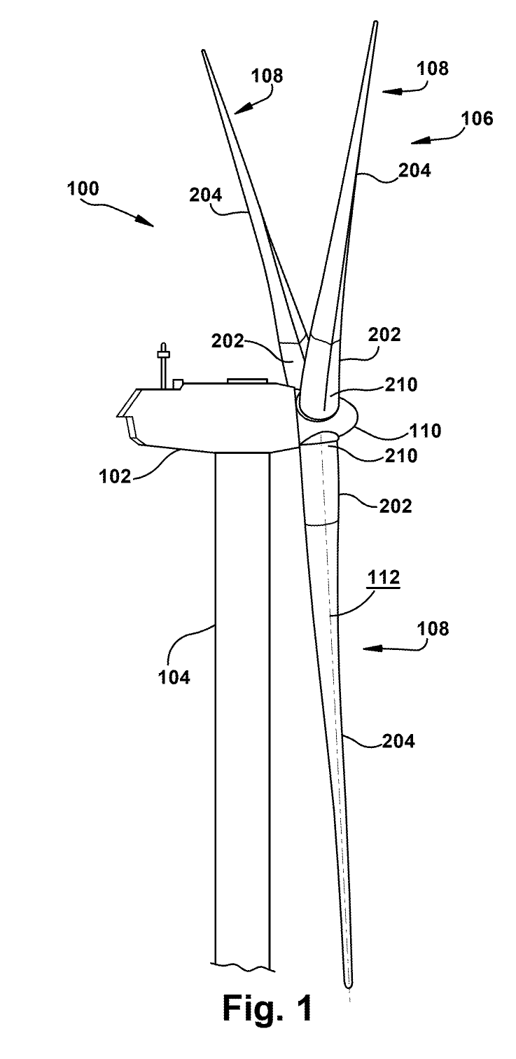

In some configurations and referring to FIG. 1, a wind turbine 100 comprises a nacelle 102 housing a generator (not shown in FIG. 1). Nacelle 102 is mounted atop a tall tower 104, only a portion of which is shown in FIG. 1. Wind turbine 100 also comprises a rotor 106 that includes a plurality of rotor blades 108 attached to a rotating hub 110. Although wind turbine 100 illustrated in FIG. 1 includes three rotor blades 108, there are no specific limits on the number of rotor blades 108 required by the present invention.

Various components of wind turbine 100 in the illustrated configuration are housed in nacelle 102 atop tower 104 of wind turbine 100. The height of tower 104 is selected based upon factors and conditions known in the art. In some configurations, one or more microcontrollers comprising a control system are used for overall system monitoring and control including pitch and speed regulation, high-speed shaft and yaw brake application, yaw and pump motor application and fault monitoring. Alternative distributed or centralized control architectures can be used in some configurations. The pitches of blades 108 can be controlled individually in some configurations, such that portions of each blade 108 are configured to rotate about a respective pitch axis 112. The pitch axis 112 is substantially parallel to the span of blade 108. Hub 110 and blades 108 together comprise wind turbine rotor 106. Rotation of rotor 106 causes a generator (not shown in the figures) to produce electrical power.

In some configurations of the present invention and referring to FIGS. 1, 2 and 3, blades 108 can comprise a plurality of sections that can be separately shipped, have multiple sections shipped in one container or manufactured on-site to facilitate transportation and/or take advantage of differences in the way inboard sections and outboard sections can be manufactured.

For example, some configurations of blades 108 comprise two sections, namely, a first non-pitchable section 202, and a second pitchable section 204. The first section 202 remains fixed compared to section 204 which can be rotated about pitch axis 112. In some embodiments section 202 and/or pitchable section 204 will comprise a plurality of sections or blade panels. For example, the pitchable section 204 and/or the non-pitchable section 202 could be comprised of six individual sections that can be joined to form one overall pitchable blade section. Any number of sub-sections can be combined to form a complete blade or a blade subsection (e.g., section 202 or section 204). It may be advantageous, in some applications, to size the individual blade sub-sections to facilitate the shipping of the blades 108. For example, a fully assembled blade could be 40 to 60 meters in length, and this results in a large and bulky item that may be difficult to transport. If the blade was divided into 4 sections, each section would be about 10 to about 15 meters in length, and this reduced length greatly facilitates the shipping and transportation of blade 108.

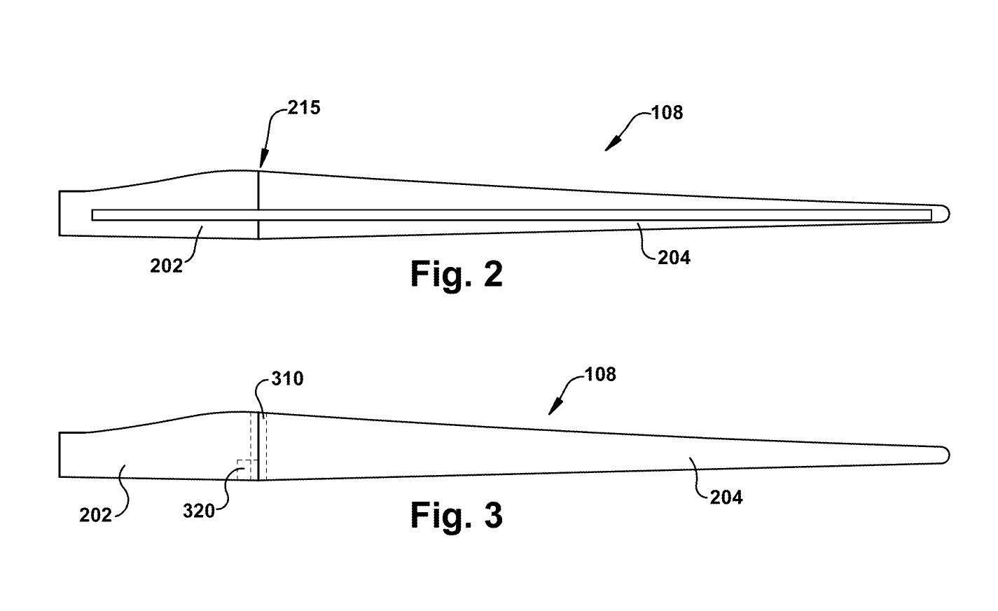

In some configurations, blade 108 is divided at a selected distance (e.g., from about 5% to about 40%) from blade root 210. In these configurations, the non-pitchable section 202 comprises from about 5% to about 40% of the length of an assembled blade 108 from blade root 210, and pitchable section 204 comprises the remaining length. A more preferred range that blade 108 could be divided at a selected distance is about 5% to about 30%. In other embodiments the blade 108 could be divided at about max chord. Max chord is defined as the point on the blade where it is the widest, and referring to FIG. 2 this would be the widest part in the north-south direction of the illustration. Non-pitchable blade section 202 can be attached to hub 110 in a fixed manner (so as not to rotate or move with respect to pitchable section 204) in some configurations, or is mechanically coupled to hub 110 (e.g., by gluing, bolting, attachment to a frame, or otherwise affixing thereto). In other embodiments non-pitchable section 202 could be attached to or manufactured as part of the nose cone or hub 110.

The non-pitchable blade section 202 can be affixed to hub 110 and may have a pitch bearing at either end. The blade 108 could be fabricated of any suitable material including, but not limited to aluminum, metal alloys, glass composites, wood laminates, carbon composites or carbon fiber. In one embodiment, a pitch bearing could be located at the interface between the non-pitchable blade section 202 and the pitchable blade section 204. This location of the pitch bearing is indicated by arrow 215 in FIG. 2. There are advantages to locating the pitch bearing away from hub 110. As the pitch bearing is moved radially outward along blade 108, the loads experienced by the pitch bearing are decreased. For example, the pitch bearing could be located radially outward along blade 108 at a distance of about 30% of the blade span. This location reduces the weight of the blade section supported by the pitch bearing, and the bending moments at the pitch bearing are also reduced. A smaller pitch bearing can be used at this location resulting in lower costs and reduced weight. Another advantage is that a smaller pitch motor could be employed in the pitch system, due to the fact that a smaller mass needs to be driven. The smaller mass also allows for a faster response time for the overall pitch system. A faster response allows the blades to be pitched more rapidly to respond to changing wind conditions. Another result of this faster response time is improved energy capture.

FIG. 3 illustrates a wind turbine blade 108 according to one embodiment of the present invention. A pitch bearing 310 connects the non-pitchable blade section 202 to the pitchable blade section 204. A pitch motor 320 can be located substantially within the non-pitchable section 202 (as shown) or substantially within the pitchable section 204. The pitch motor 320 is connected to the pitch bearing and functions to rotate section 204 about pitch axis 112. Blade section 202 does not pitch and remains fixed in comparison to rotatable or pitchable blade section 204. Typically, wind turbine blades can be pitched or rotated in increments (e.g., one degree increments from 0 to 90 degrees). A 90 degree pitch could be used to idle or stall the rotor. When the blade sections 204 are pitched to 90 degrees, the lift provided by the wind is reduced to a point insufficient to turn the rotor. This feathered state can be used when the wind turbine needs maintenance or during excessively high wind conditions.

FIG. 3 illustrates the pitch bearing 310 placed at about 20% of the blade span, however, the pitch bearing could be located between about 5% to about 40% of the blade span. A more preferred range would be to locate the pitch bearing, and the interface between the non-pitchable section 202 and pitchable section 204, at about 5% to about 30% of the blade span. In other embodiments, the pitch bearing 310 could be located at max chord (i.e., the location where the chord dimension of blade 108 is at it greatest).

During periods of very high wind speeds (e.g., during storms) the blades are typically pitched to feather. In previous blade designs, the entire blade was pitched and this sometimes resulted in very large loads experienced by the blade and the pitch bearings. As proposed by embodiments of the present invention, a reduced blade area is pitched and the remaining blade portion comprised of the non-pitchable section 202 remains fixed, or un-pitched. The un-pitched blade section 202 experiences lower storm loads and helps divert portions of the high winds around the nacelle 102. As provided by aspects of the present invention, the rotor 106 experiences reduced storm loads while the pitchable blade sections 204 (pitched to feather) are aerodynamically inefficient and prevent the rotor from turning.

Blade sections 202 and 204 can be constructed using metal alloys, glass composites, wood laminates, carbon composites, carbon fiber and/or other construction material. In some configurations in which it is used, an extra economy is achieved by limiting the use of carbon fiber to outer parts (i.e., those portions exposed to the elements) of rotor blades 108, where the carbon fibers provide maximum static moment reduction per pound. This limitation also avoids complex transitions between carbon and glass in rotor blades and allows individual spar cap lengths to be shorter than would otherwise be necessary. Fabrication quality can also be enhanced by this restriction. Another advantage of multiple section blades 108 is that different options can be used or experimented with during the development or life of a rotor 106.

As provided by aspects of the present invention, the overall hub design can be simplified. The fixed (non-pitchable) blade section 202 does not require a pitch bearing to be located within hub 110, and therefore does not require a circular cross-sectional area to connect to hub 110. The area of blade section 202 that connects to hub 110 can be of any desired shape or configuration. The blade section 202 could also be formed as an integral or distinct part of hub 110. In one embodiment, the hub 110 and low speed shaft (or main shaft) of wind turbine 100 can be manufactured as one part. This would enable the typical bolted low speed shaft/hub connection to be eliminated. The profile of blade section 202 can be extended completely to the connection flange of the hub/shaft. Another advantage is that a wider blade profile can be accommodated for blade section 202 due to the fact that this section remains fixed and does not pitch. This non-pitching section can have a greater chord dimension without the worry of interfering or contacting other wind turbine components (e.g., the nacelle 102 or tower 104).

While the invention has been described in terms of various specific embodiments, those skilled in the art will recognize that the invention can be practiced with modification within the spirit and scope of the claims.

What is claimed is:

1. A multi-section blade for a wind turbine comprising:
at least one non-pitchable section, said at least one non-pitchable section configured to be fixed to a hub of said wind turbine;
at least one pitchable section, said at least one pitchable section configured to be rotated about a pitch axis, said pitch axis oriented substantially parallel to a span of said multi-section blade;
a pitch bearing: and
a pitch motor;
wherein, said pitch bearing and said pitch motor are located within said multi-section blade and near an interface of said at least one non-pitchable section and said at least one pitchable section.

2. The multi-section blade according to claim 1, wherein said at least one non-pitchable section is configured to be substantially aerodynamic in shape and provide lift to said multi-section blade.

3. The multi-section blade according to claim 1, wherein said at least one non-pitchable section is connected to said at least one pitchable section via said pitch bearing.

4. The multi-section blade according to claim 3, wherein said pitch motor is contained substantially within said at least one non-pitchable section.

5. The multi-section blade according to claim 3, wherein said pitch motor is contained substantially within said at least one pitchable section.

6. The multi-section blade according to claim 1, wherein said at least one non-pitchable section is between about 5% to about 40% of a span length of an assembled blade.

7. A wind turbine having at least one multi-section blade, comprising:
a hub integrally formed with a low speed shaft,
at least one non-pitchable blade section configured to be fixed to said hub of said wind turbine;
at least one pitchable blade section configured to be rotated about a pitch axis, said pitch axis oriented substantially parallel to a span of said multi-section blade;
pitch means for rotating said at least one pitchable section about said pitch axis;
wherein, said pitch means are located within said multi-section blade and near an interface of said at least one non-pitchable blade section and said at least one pitchable blade section.

8. The wind turbine according to claim 7, wherein said at least one non-pitchable blade section is configured to be substantially aerodynamic in shape and provide lift to said multi-section blade.

9. The wind turbine according to claim 7, wherein said pitch means comprise at least one pitch bearing and at least one pitch motor.

10. The wind turbine according to claim 9, wherein said at least one pitch bearing is configured to connect said at least one non-pitchable blade section to said at least one pitchable blade section.

11. The wind turbine according to claim 9, wherein said at least one pitch motor is contained substantially within said at least one non-pitchable blade section.

12. The wind turbine according to claim 9, wherein said at least one pitch motor is contained substantially within said at least one pitchable blade section.

13. The wind turbine according to claim 7, wherein said at least one non-pitchable blade section is between about 5% to about 40% of a span length of an assembled blade.

14. A multi-section blade for a wind turbine comprising:
at least one non-pitchable section configured to be fixed to a hub of said wind turbine, said at least one non-pitchable section being aerodynamically shaped;
at least one pitchable section configured to be rotated about a pitch axis, said pitch axis oriented substantially parallel to a span of said multi-section blade;
pitch means for rotating said at least one pitchable section about said pitch axis;
wherein, said pitch means are located within said multi-section blade and near an interface of said at least one non-pitchable section and said at least one pitchable section.

15. The multi-section blade according to claim 14, wherein said pitch means comprise at least one pitch bearing and at least one pitch motor.

16. The multi-section blade according to claim 15, wherein said at least one pitch bearing is configured to connect said at least one non-pitchable section to said at least one pitchable section.

17. The multi-section blade according to claim 16, wherein said at least one pitch motor is contained substantially within said at least one non-pitchable section.

18. The multi-section blade according to claim 16, wherein said at least one pitch motor is contained substantially within said at least one pitchable section.

19. The wind turbine according to claim 14, wherein said at least one non-pitchable section is between about 5% to about 40% of a span length of an assembled blade, and said at least one pitchable section comprises about 60% to about 95% of a span length of an assembled blade.
